(19) United States
(12) Patent Application Publication
(10) Pub. No.: US 2007/0245928 A1
(43) Pub. Date: Oct. 25, 2007

(54) Hydrated catalytic coating

(76) Inventors: Jeff E. Bennert, Amarillo, TX (US); Ion C. Bennert, Amarillo, TX (US); Ronnie L. Roberson, Amarillo, TX (US); Mary J. Roberson, Amarillo, TX (US)

Correspondence Address: LITMAN LAW OFFICES, LTD., P.O. BOX 15035, CRYSTAL CITY STATION, ARLINGTON, VA, 22215, US

(21) Appl. No.: 11/715,466

(22) Filed: Mar. 8, 2007

Related U.S. Application Data
(60) Provisional application No. 60/780,880, filed on Mar. 10, 2006.

(51) Int. Cl. C09D 1/00

(52) U.S. Cl. 106/287.17; 106/287.34; 106/287.35; 977/777

(57) ABSTRACT

The hydrated catalytic coating is a coating that is applied to a substrate or target structure in the path of a broad spectrum ultraviolet light in the 100 nm to 300 nm range to decompose ozone. The coating is particularly useful in conjunction with germicidal UV lamps emitting UV radiation at 185 nm and 254 nm. The coating is a combination of a hydrophilic agent and the following metals: titanium dioxide (TiO₂); silver (Ag); copper (Cu); nickel (Ni); and rhodium (Rh). At least three of the five metals are present as particles in the 50-100 nm range. The nanosize particles increase the surface area of the catalyst, improving the kinetic rate of reaction and the total reduction in ozone concentration. The particular mixture of catalytic metals and absorbed water also results in reaction products that have antimicrobial effect, including hydroxyl radicals and ions, superoxides, hydro peroxides and ozonide ions.

### CROSS-REFERENCE TO RELATED APPLICATION

This application claims the benefit of U.S. Provisional Patent Application Ser. No. 60/780,880, filed Mar. 10, 2006.

### BACKGROUND OF THE INVENTION

1. Field of the Invention

The present invention relates to catalysts for the decomposition of ozone, and particularly to a hydrated catalytic coating for breaking down ozone produced by ultraviolet light into nontoxic radicals and compounds.

2. Description of the Related Art

In recent years there is an increased awareness of the environmental hazards resulting from airborne microorganisms, including bacteria, mold, fungus, viruses, yeasts, protozoa, and other microbes. Similar concerns have been raised about contamination of our water sources, whether from municipal water supplies processed by water treatment facilities, or from wells and septic tank systems. One mode of germicidal treatment common to both air and water is the ozone generator, which makes use of the strong oxidation property of ozone that is reputed to be toxic to many forms of microbes.

Another mode of treatment is ultraviolet (UV) radiation. UV radiation in the range of 100 nm to 300 nm (the UVC bandwidth) is known to have germicidal effect, the energy from UV radiation disrupting DNA in both plant and animal microbes. UV radiation at 254 nm is a particularly effective germicidal agent, having an energy level very close to the 265 nm wavelength known to disrupt certain amino acid bonds prevalent in microbial DNA. UV light at wavelengths less than 200 nm have higher energy, but are also known to generate ozone, which is both toxic and also reputed to damage air conditioner coils. Some UV germicidal lamps have special filters built in to the quartz envelope to filter out UV radiation lower than 200 nm in order to retain the germicidal 254 nm wavelength without also generating ozone. However, other UV lamps for both air and water purification do not have such filtering and will generate UV radiation below 200 nm, particularly at high power.

Other UV lamps for both air and water purification are intentionally built as dual wavelength lamps, generating UV at both 254 nm and 185 nm. UV at 185 nm is useful in purification systems, since UV at this wavelength reduces the total organic compounds (TOC), generally disrupting hydroxyl bonds and generating hydroxyl ions, which increases the germicidal effect. UV lamps in air purification systems may be disposed in or adjacent to the ducts of a ventilation system in residences, businesses and vehicles, for example, in order to reduce the level of airborne microorganisms.

The generation of ozone by UV light in water purification systems is not as much of an acute problem, since water tends to absorb UV radiation, although water purification systems that utilize ozone must also provide a means for decomposing the ozone to nontoxic compounds after achieving purification of the water (the FDA permits a maximum residual concentration of ozone as an antimicrobial agent in bottled water of 0.4 mg/L). However, the coincidental generation of ozone in UV air purification systems is a hazard due to the known adverse health effects caused by airborne ozone, including irritation of the eyes and mucosal membranes, pulmonary edema, and chronic respiratory disease. The NIOSH REL (recommended exposure limit) TWA (time-weighted average) concentration for up to a 10-hour workday during a 40-hour workweek for ozone is a ceiling of 0.1 ppm (0.2 mg/m³). The OSHA PEL (permissible exposure limit) or TWA concentration that must not be exceeded during any 8-hour work shift of a 40-hour workweek is also 0.1 ppm. The IDHL (immediately dangerous to life or health) concentration of ozone is 5 ppm.

In addition to the use or coincidental production of ozone in connection with air purification systems, ozone is also produced as a byproduct of certain machinery, notably photocopy machines, electrical generators, etc.

Although various catalysts have been devised for decomposing ozone to nontoxic compounds, none describe the composition of the present invention, which is effective for the reduction of ozone levels generally, and is particularly effective for reducing ozone levels produced by germicidal or antimicrobial UV radiation in the UVC bandwidth. Thus, a hydrated catalytic coating solving the aforementioned problems is desired.

### SUMMARY OF THE INVENTION

The hydrated catalytic coating is a coating applied to a substrate or target structure in the path of a broad spectrum ultraviolet light in the 100 nm to 300 nm range for the decomposition of ozone. The coating is a combination of a hydrophilic agent and the following metals: titanium dioxide (TiO₂); silver (Ag); copper (Cu); nickel (Ni); and rhodium (Rh). At least three of the five metals are present as particles in the 50-100 nm range. The nanosize particles increase the surface area of the catalyst, improving the kinetic rate of reaction as well as the total reduction in ozone concentration. The particular mixture of metals also results in reaction products that have antimicrobial effect, including hydroxyl radicals and ions, superoxides, hydro peroxides, and ozonide ions.

These and other features of the present invention will become readily apparent upon further review of the following specification.

### DETAILED DESCRIPTION OF THE PREFERRED EMBODIMENTS

The present invention is a hydrated catalytic coating that is applied to a substrate or target structure in the path of a broad spectrum ultraviolet light in the 100 nm to 300 nm range for the decomposition of ozone. It is particularly useful in conjunction with germicidal UV lamps emitting UV radiation at 185 nm and 254 nm. The coating is a combination of a hydrophilic agent and the following metals: titanium dioxide (TiO₂); silver (Ag); copper (Cu); nickel (Ni); and rhodium (Rh). At least three of the five metals are present as particles in the 50-100 nm range. The nanosize particles increase the surface area of the catalyst, improving the kinetic rate of reaction as well as the total reduction in ozone concentration. The particular mixture of metals also results in reaction products that have antimicrobial effect, including hydroxyl radicals and ions, superoxides, hydro peroxides and ozonide ions, all of which are strong oxidants. These reaction products are also effective in reducing odors and volatile organic compounds due to their strong oxidizing properties.

The hydrophilic agent is preferably silica gel. Alumina may be used in lieu of silica gel, but alumina has a tendency to lose moisture at lower temperatures than silica gel. The hydrophilic gel serves to attract moisture to the coating, either absorbing or adsorbing the water, which hydrates the coating and reacts in combination with the metal catalysts (by donating hydrogen to the ozone) to decompose ozone to form hydroxide ions and radicals, as well as hydro peroxides, such as the HO₂ radical and hydrogen peroxides, which are desirable reaction products from the decomposition of ozone due to their strong oxidizing properties, which enhances the germicidal effect of UV radiation. The silica gel both serves as a carrier for the metal catalyst and hydrates the catalyst by the attraction and absorption or adsorption of water both from water used during formulation of the coating and from water absorbed from ambient air in the environment. Other desiccants or hydrophilic agents that attract or absorb moisture may also be use in lieu of silica gel.

The present inventors have found that the combination of the hydrophilic agent with the five metal constituents provides an effective catalyst for the decomposition of ozone with a faster kinetic rate of reaction and more complete reduction of ozone levels when at least three of the metals are nanoparticles in the range of 50 nm to 100 nm. Various combinations have been found effective, but a particularly preferred embodiment comprises by weight about 1% nanosize nickel, about 7% nanosize silver, about 7% micron size rhodium, about 14% nanosize copper, and about 70% micron size titanium dioxide combined with sufficient silica gel to support the metal catalysts in dispersed fashion. It will be understood, however, that each of the metal constituents may comprise anywhere between 1% and 90% of the metallic portion of the catalytic coating of the present invention, exclusive of the hydrophilic agent.

The coating may be applied to any appropriate substrate, which is then disposed 360° around the UV lamp. An exemplary substrate is a perforated or porous aluminum substrate that may have a cellular form, e.g., round aluminum discs or washers separated by spacers. The cellular substrate permits the passage of UV radiation and the flow of air though the substrate, but any ozone produced by the UV radiation, which will be in greater concentration closer to the lamp, will be decomposed when passing through the cellular substrate by reaction with the hydrated catalytic coating. A primer may be necessary to apply the coating to the substrate. The present inventors have found that a zinc chromate self-etching primer is effective for use with aluminum. Plastic or other substrates may be used instead of aluminum with an appropriate primer. The coating itself is preferably mixed with a low VOC (volatile organic compound) titanium-based paint. The substrate may be dipped in the catalyst-paint mixture, and the excess coating is spun off using transciprocal force. Other processes may be used for applying the coating to the substrate, such as application of a polymer, powder coating, adhesives, etc.

The ultimate effect of the metal catalysts is to reduce ozone to neutral molecules. Each of the five metal constituents contribute to the effectiveness of the catalytic coating, since the different metal ion intermediates contribute to different reaction products, viz., hydroxide ions or hydroxyl radicals, superoxides, hydro peroxides and ozonide ions. These reaction products, in turn, are nontoxic oxidizing agents that contribute to antimicrobial activity, as well as the reduction of odors and volatile organic compounds, and are ultimately are reduced to neutral oxygen.

A representative example of the hydrated catalytic coating will now be described. It will be understood that the following example is for purposes of illustration of the manner of making and using the invention, and not by way of limitation, i.e., the choice of which of the five metals are nanoparticles and which are micron size may vary, as well as the percentage composition of each metal, and the hydrophilic agent may vary from that described in the following example.

### EXAMPLE

A slurry of the metal catalysts was prepared by mixing by weight 1% nanosize nickel, 7% nanosize silver, 7% micron size rhodium, 14% nanosize copper, and 70% micron size titanium dioxide with distilled water. Distilled or de-ionized water is considered a significant feature of the coating, since ordinary tap water is ionized and causes too much agglomeration of the particles. The use of distilled or de-ionized water helps to keep the particles of the coating dispersed, which, together with the nanosize of at least three of the metal constituents, presents a greater catalytic surface area to the flow of ozone than micron size particles. Some agglomeration of the particles is inevitable but electron microscopy of the hydrated catalytic coating of the present invention has shown that the use of distilled water provides for greater dispersion of the metal catalysts.

After the slurry was prepared, more than fifty grams of silica were mixed with distilled water and allowed to settle until the majority of the water had been absorbed and the mixture began to gel. This hydrated silica was then combined with the metallic slurry. The hydrated silica/metal slurry mixture was then added to a low VOC titanium-based paint to form the final coating. A cellular aluminum substrate of the type described above was primed with self-etching zinc chromate. The coating was then applied to the cellular aluminum substrate by dipping the substrate into the paint and spinning off the excess using transciprocal force.

The substrate was placed 360° around an HE/UV mercury lamp emitting UV radiation between 100 nm and 300 nm, including at 185 nm and 254 nm. The lamp was disposed in the duct of a ventilation system. A digital ozone meter having an accuracy to 0.01 ppm was used to test the ozone levels directly over the outlet vent, then three inches from the vent, then six inches from the vent, and finally the ambient air in the room. Tests were conducted on a UV lamp without a surrounding substrate, a UV lamp surrounded by an aluminum substrate coated by paint containing only titanium dioxide, and by a UV lamp surrounded by a substrate coated with the test hydrated catalytic coating as prepared above.

The results of the testing are summarized in the following table.

Test Results

| | | UV Lamp with | |
|---|---|---|---|
| | UV Lamp with no | TiO₂ coated | UV Lamp with |
| | substrate | substrate | Test coating |
| Directly over | 0.45 ppm | 0.09 ppm | 0.04 ppm |
| Vent | | | |
| 3″ over vent | 0.28 ppm | 0.04 ppm | 0.02 ppm |
| 6″ over vent | 0.26 ppm | 0.03 ppm | 0.01 ppm |
| Ambient room air | 0.07 ppm | 0.01 ppm | 0.00 ppm |

It is to be understood that the present invention is not limited to the embodiments described above, but encompasses any and all embodiments within the scope of the following claims.

We claim:

1. A hydrated catalytic coating for reducing ozone concentration in the presence of ultraviolet radiation, comprising:
an effective amount of particles of metal catalysts including titanium dioxide, silver, copper, rhodium and nickel, at least three of the catalysts being nanosize particles in the range of 50 nm to 100 nm in order to increase surface area of the catalysts exposed to the ozone; and
a hydrophilic agent forming a carrier for the metal catalyst particles.

2. The hydrated catalytic coating according to claim 1, further comprising water absorbed or adsorbed by said hydrophilic agent.

3. The hydrated catalytic coating according to claim 1, wherein said water comprises distilled water, whereby said particles of metal catalysts are dispersed throughout the coating.

4. The hydrated catalytic coating according to claim 1, wherein said water comprises de-ionized water, whereby said particles of metal catalysts are dispersed throughout the coating.

5. The hydrated catalytic coating according to claim 1, further comprising paint, said metal catalysts and said hydrophilic agent being mixed with the paint.

6. The hydrated catalytic coating according to claim 1, wherein said particles are substantially dispersed throughout said carrier in order to provide increased surface area of said metal catalysts exposed to the ozone.

7. The hydrated catalytic coating according to claim 1, wherein said hydrophilic agent comprises silica gel.

8. The hydrated catalytic coating according to claim 1, wherein said hydrophilic agent comprises alumina.

9. The hydrated catalytic coating according to claim 1, wherein said particles of titanium dioxide, said particles of silver, said particles of copper, said particles of rhodium and said particles of nickel each comprise between about 1% and 90% by weight of the coating.

10. The hydrated catalytic coating according to claim 1, wherein:
said particles of titanium dioxide comprise about 70% by weight of the coating;
said particles of copper comprise about 14% by weight of the coating;
said particles of rhodium comprise about 7% by weight of the coating;
said particles of silver comprise about 7% by weight of the coating; and
said particles of nickel comprise about 1% by weight of the coating.

11. The hydrated catalytic coating according to claim 1, wherein said particles of titanium dioxide and rhodium are micron-sized and said particles of copper, silver and nickel are nano-sized.
